(19) United States
(12) Patent Application Publication
(10) Pub. No.: US 2025/0053965 A1
(43) Pub. Date: Feb. 13, 2025

(54) SIGNATURE-BASED ATOMIC SWAP

(71) Applicant: nChain Licensing AG, Zug (CH)

(72) Inventors: Katharine MOLLOY, London (GB); Craig Steven WRIGHT, London (GB); Wei ZHANG, London (GB)

(21) Appl. No.: 18/720,520

(22) PCT Filed: Nov. 23, 2022
(86) PCT No.: PCT/EP2022/082968

§ 371 Date: Jun. 14, 2024

(30) Foreign Application Priority Data
Dec. 21, 2021 (GB) 2118682.0

(51) Int. Cl. G06Q 20/38; H04L 9/00

(52) U.S. Cl. CPC G06Q 20/3825; H04L 9/50

(57) ABSTRACT

A method performed in a system comprising a first party and a second party, the method comprising: generating, by the first party, a template of a first transaction having an input based on an output from a prior transaction associated with the second party; generating, by the first party, a message based on the template of the first transaction; generating, by the first party, a secret based on the message; generating, by the first party, a value based on the secret, wherein the secret cannot be derived from the value; generating, by the first party, a first puzzle transaction, wherein a first locking script of the first puzzle transaction comprises a knowledge proof configured to require an unlocking script to comprise the secret; publishing, by the first party, the first puzzle transaction to a first blockchain; obtaining, by the second party, the value based on the secret; signing, by the second party, the value based on the secret to create a signature; sending the signature from the second party to the first party; including, by the first party, the signature in the unlocking script of the first transaction and then sending the first transaction to a second blockchain; determining, by the second party and from the first transaction on the second blockchain, the message and the secret; and creating, by the second party, a second transaction which unlocks a first output of the first puzzle transaction based on the secret, and submitting the second transaction to the first blockchain.

### CROSS REFERENCE TO RELATED APPLICATIONS

This application is the U.S. National Stage of International Application No. PCT/EP2022/082968 filed on Nov. 23, 2022, which claims the benefit of United Kingdom Patent Application No. 2118682.0, filed on Dec. 21, 2021, the contents of which are incorporated herein by reference in their entireties.

### TECHNICAL FIELD

The present disclosure relates to a method for securely making transactions. The method is applicable to blockchain technology.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below.

Transactions that are submitted to the blockchain network are included in new blocks. New blocks are created by a process often referred to as “mining”, which involves each of a plurality of the nodes competing to perform “proof-of-work”, i.e., solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e., a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance, this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g., a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e., a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e., a reference) to such an output in a preceding transaction, and may further comprise an unlocking script for unlocking the locking script of the pointed-to output. So, consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring to the UTXO of a preceding transaction in a sequence of past transactions, but rather by reference to an absolute account balance. The current state of all accounts is stored by the nodes separate to the blockchain and is updated constantly.

### SUMMARY

In some examples, a secret value based on the signature message of an unpublished transaction is determined. A puzzle transaction that can be unlocked by the secret is generated and published before the secret transaction is revealed. When the secret transaction is published it creates an atomic swap between two parties. This increases security by preventing either party from being able to “cheat” each other.

According to one aspect disclosed herein, there is provided a method performed in a system comprising a first party and a second party. The method comprises generating, by the first party, a template of a first transaction having an input based on an output from a prior transaction associated with the second party. The method can include generating, by the first party, a message based on the template of the first transaction and generating, by the first party, a secret based on the message. The method can also include generating, by the first party, a value based on the secret, wherein the secret cannot be derived from the value and generating, by the first party, a first puzzle transaction, wherein a first locking script of the first puzzle transaction comprises a knowledge proof configured to require an unlocking script to comprise the secret. The method may include the first party publishing the first puzzle transaction to a first blockchain and second party obtaining the value based on the secret and signing the value based on the secret to create a signature. The method may further comprise sending the signature from the second party to the first party and including, by the first party, the signature in the unlocking script of the first transaction and then sending the first transaction to the second blockchain. The method may also include determining, by the second party and from the first transaction on the second blockchain, the message and the secret and creating, by the second party, a second transaction which unlocks a first output of the first puzzle transaction based on the secret and submitting the second transaction to the first blockchain.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 is a schematic diagram of 6 different kinds of sighash flags,

FIG. 6 is an example method flow, and

FIG. 7 is an example method flow.

### DETAILED DESCRIPTION OF EMBODIMENTS

### Example System Overview

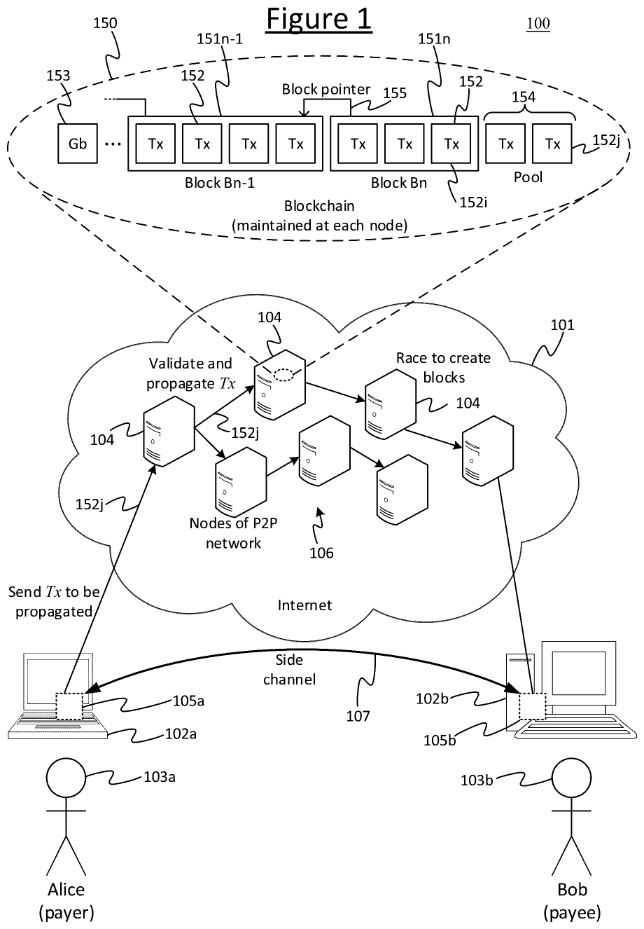

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g., one or more central processing units (CPUs), accelerator processors, application specific processors and/or field programmable gate arrays (FPGAs), and other equipment such as application specific integrated circuits (ASICs). Each node also comprises memory, i.e., computer-readable storage in the form of a non-transitory computer-readable medium or media. The memory may comprise one or more memory units employing one or more memory media, e.g., a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user to be unlocked and thereby redeemed or spent). Each input points back to the output of a preceding transaction 152, thereby linking the transactions.

Each block 151 also comprises a block pointer 155 pointing back to the previously created block 151 in the chain to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases, a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g., UTXO) is assigned (e.g., spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g., the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore, this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g., having obtained a copy of the blockchain from a blockchain node 104).

Some or all of the parties 103 may be connected as part of a different network, e.g., a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g., one or more CPUs, GPUs, other accelerator processors, application specific processors, and/or FPGAs. The computer equipment 102 of each party 103 further comprises memory, i.e., computer-readable storage in the form of a non-transitory computer-readable medium or media. This memory may comprise one or more memory units employing one or more memory media, e.g., a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g., a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g., downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g., interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g., this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

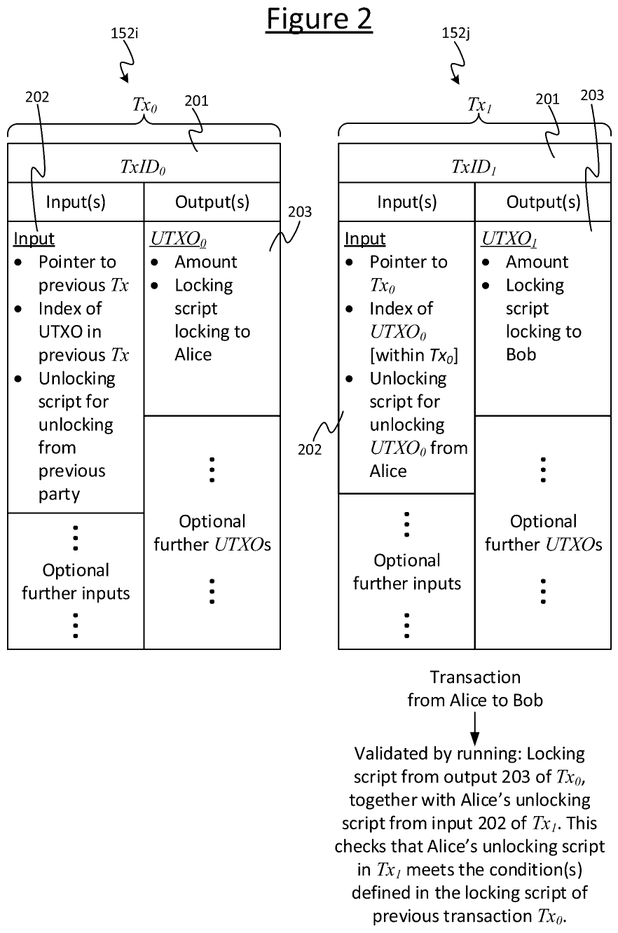

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx-”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig PA] which requires a signature Sig PA of Alice in order for UTXO₀ to be redeemed (strictly, in order for a subsequent transaction attempting to redeem UTXO₀ to be valid). [Checksig PA] contains a representation (i.e. a hash) of the public key PA from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx/further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

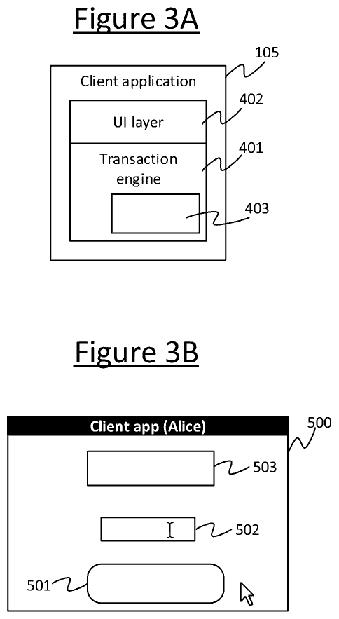

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 502. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### Node Software

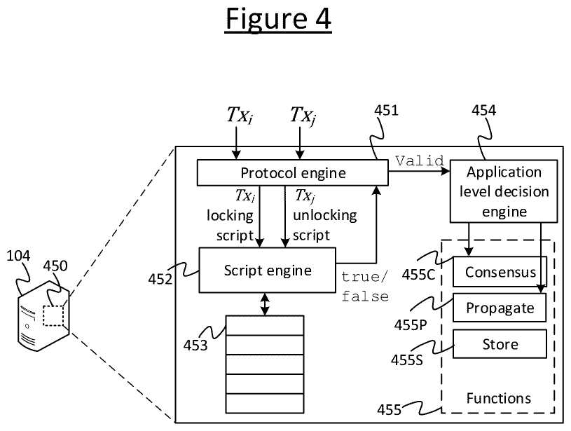

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Tx; and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txᵢ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### Blockchain Signature Messages

An example blockchain transaction is shown schematically in Table 1. The blockchain transaction may comprise a Bitcoin transaction, for example. In the example of Table 1, the transaction comprises two inputs and three outputs, however it will be understood that in other examples different numbers of inputs and outputs may be used.

TABLE 1
Example blockchain transaction
TxID
Version

| | Inputs | | | Outputs | |
|---|---|---|---|---|---|
| | Outpoint | Unlocking | | | Locking |
| Index | (TxID, index) | Script | nSeq | Value | Script |
| 0 | Outpointᵢ | UnlockScriptᵢ | nSeqᵢ | vₓ | LockScriptₓ |
| 1 | Outpointⱼ | [sig(m, a)] [P] | nSeqⱼ | v_{y} | LockScript_{y} |
| 2 | | | | v_{z} | LockScript_{z} |

Locktime

In the example of Table 1, the outpoint that is used in index 2 comprises a pay-to-public-key-hash (P2PKH) locking script that specifies the public key P. Index 2 therefore requires an unlocking script that provides a signature generated using the associated private key, a, and a message, m.

Blockchain signature messages (e.g., Bitcoin signature messages) are derived from details of the transaction that is being signed. As such, in addition to proving that the user holds the appropriate private key, the signature also ensures the integrity of any details within the transaction that are included in the signature message. If signed transaction details are modified, the signature verification process will fail.

In the example of Table 1, the TxID field and unlocking script fields are never included in the signature message, since they must be created and/or edited after the signature has been generated. The Version and Locktime fields are always included in the signature message, as are the details of the input that the signature is used to validate (e.g., Outpointⱼ and nSeqⱼ). The message may also include details of the other inputs and any transaction outputs, depending on which sighash flag is used during signing.

### Sighash Flags

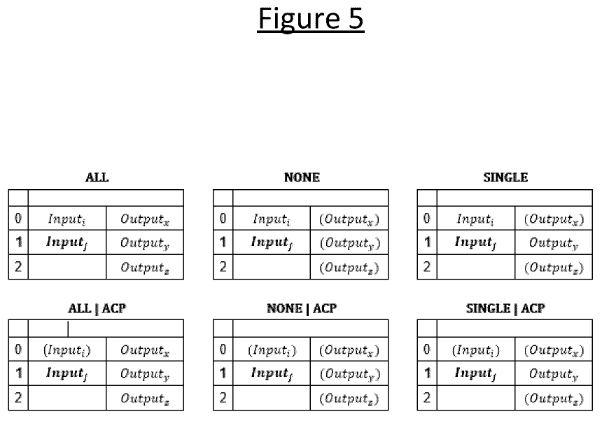

FIG. 5 shows six schematics of inputs and outputs which are included in the signature message using six different sighash flags. Inputs or outputs that are bracketed (surrounded by parentheses) indicate that an element that will not be signed. Inputs or outputs that are included in the signature message are not bracketed (not surrounded by parentheses).

In the six sighash flag types shown in FIG. 5, each sighash flag type allows a signature to selectively endorse (and fix the details of) either all inputs and outputs, or various subsets. The different sets are illustrated in FIG. 5 based on a signature that unlocks the input in index 1. The input that the signature applies to is always signed.

According to an example, the full signature message based on the transaction illustrated in Table 1 and signing for input 1, is constructed as follows:

| | |
|---|---|
| m = | [Version][Hash(Outpoints)][Hash(nSeqs)][Outpointₖ]... |
| | [LockScriptLengthₖ][LockScriptₖ][Valueₖ][nSeqₖ][Hash(Outputs)]... |
| | [Locktime][Flag] |

The single byte field Flag at the end of the message indicates the sighash flag, which may correspond to one of the six sighash flag types shown in FIG. 5. The fields [Hash(Outpoints)], Hash(nSeqs) and Hash(Outputs)) will contain different information depending on the sighash flag used. In cases where the hash fields would involve hashing an empty value (e.g., Hash(Outputs) when using the NONE flag), the field value is set to 0. In such examples, the notation Hash(empty) may be used to indicate these cases.

FIG. 5 illustrates the six sighash flag types and which inputs and outputs are included in the signature message for each. The top row of tables shows the ‘regular’ sighash flag variants which sign all inputs, and ALL, NONE or a SINGLE output. The bottom row of tables illustrates the ‘anyone can pay’ (ACP) variants, where only a single input—that in index 1 where the signature is placed—is included in the signing message.

### Hash Puzzles

### Hash Functions

Hash functions are cryptographic functions that convert an input of variable length into an output of a specific length. Hash functions may have the following properties:
Deterministic: using the same input will always return the same output,
Unpredictable: a small change in the input results in a large change in the output,
One-way: given only the output it is computationally infeasible to reconstruct the input, and
Collision-resistant: the likelihood of two inputs resulting in the same output value is extremely small.

The precise likelihood of a collision depends on the size of the output, with larger outputs resulting in fewer collisions. Examples of hash functions include RIPEMD-160, SHA-1 and SHA-256.

### Bitcoin Hash Puzzles

Although Bitcoin transactions traditionally use a Pay to Public Key Hash (P2PKH) locking scripts, since the Genesis upgrade in February 2020 a variety of non-standardised locking scripts are valid. One of these is the hash puzzle, where a locking script is set such that a user must provide the preimage of a certain hash value in order to spend a UTXO.

For a pre-image, s, H₂₅₆(s) may be the hash digest from the SHA-256 hash function. A Bitcoin hash puzzle for this value can be implemented by creating a UTXO that has the following locking script:
OP_SHA256 <H₂₅₆(s)> OP_EQUALVERIFY

In order to spend this UTXO, a user must know the value of the preimage, s. This is used as the unlocking script in a transaction that spends the UTXO. During verification, the SCRIPT engine concatenates the unlocking and locking scripts to give:
<s> OP_SHA256 <H₂₅₆(s)> OP_EQUALVERIFY

The OP_EQUALVERIFY code will return a value of 1 if and only if:

$$SHA - 256 ( s ) = {H}_{256} ( s )$$

i.e., the transaction will only be valid if the user submitted the correct preimage. This style of locking script puzzle relies on the collision-resistant property of hash functions: only a user who knows the (secret) value of s can ‘solve’ the hash puzzle.

### Security

Although a hash puzzle cannot be solved by anyone who does not know the required preimage, once a transaction is constructed by a user who does know the secret preimage value it must be broadcast to the Bitcoin network and published to the blockchain. There is a vulnerability to attack after the transaction has been sent to the Bitcoin network: any party who receives the transaction details becomes aware of the secret value, which is sufficient to authorise the spend of the puzzle UTXO. Since no signature is required in the unlocking script, a malicious party could change the details of the output without invalidating the transaction.

To address this malleability, hash puzzles can be combined with an additional OP_CHECKSIG requirement, to tie the UTXO to the public key of a specific user. For example, for a user with public key P, and using the notation H₁₆₀(x) to represent the RIPEMD-160 hash of x, a hash puzzle locking script could be constructed as follows:
OP_SHA256 <H₂₅₆(s)> OP_EQUALVERIFY OP_DUP OP_HASH160
<H₁₆₀(P)> OP_EQUALVERIFY OP_CHECKSIG

This puzzle requires the following input in the unlocking script:
<sigₚ><P><s>
   A puzzle for this format locks the UTXO to a particular user and can only be spent if the user knows the required secret preimage. The resulting transaction will be secure against malleation of any values that were included in the signature message used to create sigₚ.

As noted above, the transaction information that is included in the signature message may depend on the sighash flag used.

### Secret Access Tokens

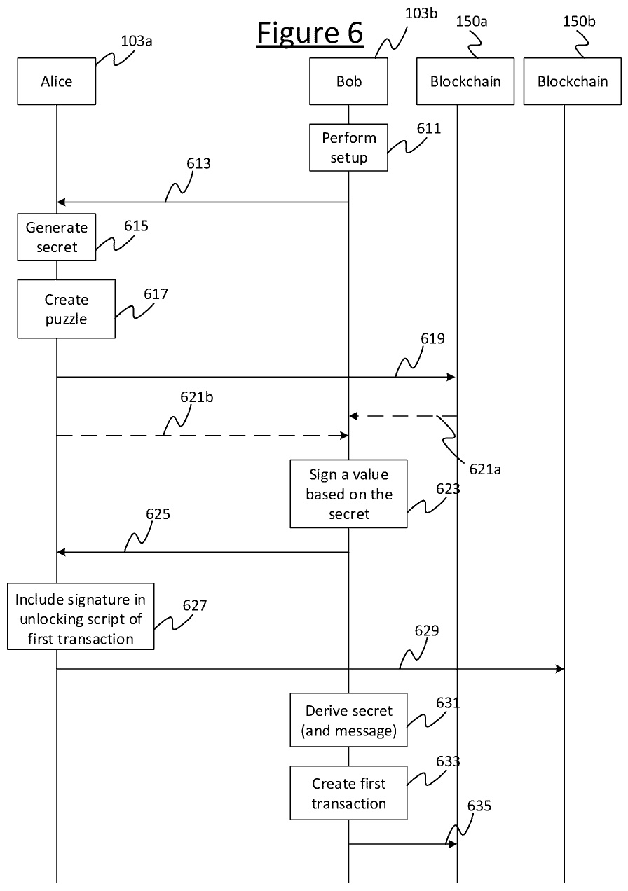

FIG. 6 shows an example method for controlling access to a resource (e.g., a data resource) that is owned by a first party. The first party may comprise one or more users. In this example, the first party is Alice 103a. In some examples, the resource may comprise a data resource or a physical resource and Alice may be an oracle, or some other type of trusted third party. In some examples, a party (e.g., Bob 103b) may apply for access to the resource, and access is granted by the oracle if certain conditions (e.g., paying sufficient fee or passing identity checks) are met. In other examples, the method may be used for Bob 103b to purchase goods from Alice 103a in a transaction.

Alice 103a and Bob 103b may need to use one or more private keys across the protocols described in this section. P_{A} and P_{B} refer to a generic public key from a set of single-use private-public key pairs that Alice 103a or Bob 130b, respectively, hold. It will be appreciated that although they share notation each key is unique. The notation P_{A}*, P_{B1}*, P_{B2}* etc. refer to single, specific public keys that are used within the protocol. Each key has consistent notation, i.e., all instances of P_{A}* refer to the same public key.

As part of some signature algorithms such as the ECDSA signature algorithm, signature messages are double-hashed (i.e., the SHA-256 hashing algorithm is applied twice). The values of both the single- and double-hashes of the signature message, which for a message, m, are defined as follows:

$$Single - hash : {h}_{1} = {H}_{256} ( m )$$

$$Double - hash : {h}_{2} = {H}_{256} ( {h}_{1} ) = {H}_{256} ( {H}_{256} ( m ) )$$

In some examples, hash algorithms other than the SHA-256 algorithm may be used (such as an R-puzzle algorithm or a different SHA algorithm, e.g. SHA-512). h₁ may be determined by hashing message m using a hashing algorithm once and h₂ may be determined by hashing message m twice using a hashing algorithm.

Alice 103a may considered to be a first party in some examples. Bob 103b may considered to be a second party in some examples.

### S|ACP Tokens

At 611, Bob 103b generates TxIDₛₑₜᵤₚ, in which he assigns the fee required for access to his public key, P_{B1}*. Bob 103b can also include data pertaining to his application for access (e.g., encrypted identity proof) in an OP_RETURN of that output. The setup transaction may be published on-chain. Table 2 shows an example of TxIDₛₑₜᵤₚ. In all examples herein, TxIDₛₑₜᵤₚ may be considered to be a prior transaction.

TABLE 2
TxIDₛₑₜᵤₚ generated, in some examples, by Bob 103b at 611.
TxIDₛₑₜᵤₚ
Version

| | Input | | | Output | |
|---|---|---|---|---|---|
| | | Unlocking | | | Locking |
| Index | Outpoint | Script | nSeq | Value | Script |
| 0 | Bob's | <Sig ALL> | n₀ | fee | P2PKH P_{B1}* |
| | input | <P_{B}> | | | OP_RETURN <data> |
| 1 | | | | change | P2PKH P_{B} |

Locktime

At 613, Bob 103b sends details of the UTXO: TxIDₛₑₜᵤₚ ∥ 0 and another of his public keys P_{B2}* to Alice 103a.

At 615, Alice 103a generates a template of a first transaction, TxIDₛₐₗₑ. The first transaction may have Bob's UTXO: TxIDₛₑₜᵤₚ ∥ 0 as an input and assigns the value to P_{A}*. In some examples, Bob 103b does not know the details of P_{A}*.

TABLE 3
TxIDₛₐₗₑ template generated by Alice 103a at 615.
Template: TxIDₛₐₗₑ
Version

| | Input | | | Output | |
|---|---|---|---|---|---|
| Index | Outpoint | Unlocking Script | nSeq | Value | Locking Script |

| | | | | |
|---|---|---|---|---|
| 0 | TxIDₛₑₜᵤₚ \|\| 0 | n₀ | fee | P2PKH P_{A}* |

Locktime

TxIDₛₐₗₑ may be considered to be a first transaction and has an input based on the output of the prior transaction TxIDₛₑₜᵤₚ. An output of the first transaction may be locked to a public key of the first party.

At 615. Alice 103a calculates h₁ and h₂, the single- and double-hash of the S|ACP signature message, m, of the template for TxIDₛₐₗₑ. As such the message is based on the template of the first transaction. Message m may be determined using the following, for example:

$$m = [ Verison ] [ Hash ( {Outpoint}_{0} ) ] [ Hash ( {nSeq}_{0} ) ] [ {Outpoint}_{0} ] [ {LockScriptLength}_{0} ] [ {LockScript}_{0} ] [ {Value}_{0} ] [ {nSeq}_{0} ] [ Hash ( {Output}_{0} ) ] [ Locktime ] [ S \vert ACP ]$$

As seen in the above equation, in this example, an S|ACP sighash flag is used.

A secret, h₁, can then be determined based on message m. In some examples, h₁ can then be determined by hashing message m, for example by using a SHA-256 hash.

A value based on h₁ i.e., a value based on the secret, is denoted as h₂. In some examples, h₁, can then be determined by hashing secret h₁, for example by using a SHA-256 hash.

Although Bob 103b knows the details of the input, he cannot guess the details of the output that Alice 103a has defined, so the value h₁ is unknown to Bob 103b. This allows h₁ to act as the secret.

At 617, Alice 103a creates TxID_{puzzle} that assigns a small value (which in some examples may be sufficient to cover the transaction fee at 631) to an output with a locking script hash puzzle that requires the secret h₁ to solve.

TABLE 4
TxID_{puzzle} generated by Alice 103a at 617.
TxID_{puzzle}
Version

| | Input | | | Output | |
|---|---|---|---|---|---|
| Index | Outpoint | Unlocking Script | nSeq | Value | Locking Script |
| 0 | Alice's input | <Sig ALL><P_{A}> | n₀ | dust | Puzzle |
| 1 | | | | x | P2PKH P_{A} |

Locktime

For example, the puzzle in the locking script may take the following form:
OP_SHA256 <h₂> OP_EQUALVERIFY P2PKH P_{B2}*

This UTXO can only be spent by Bob 103b, and only once he knows the value of the secret, h₁ that is the preimage to h₂. Note that it is possible for Alice 103a to generate multiple puzzle UTXOs in a single transaction. Each will have a unique value of h₂ and be associated with one user's public key.

At 619, Alice 103a signs TxID_{puzzle} and it is published to a first blockchain 150a. In some examples, first blockchain 150a is the same blockchain as second blockchain 150b. In some examples, first blockchain 150a is a different blockchain compared to second blockchain 150b. For example, the first blockchain 150a may be a proof-of-work blockchain and the second blockchain may e be a proof-of-stake blockchain 150b, or vice versa.

At 621b, Alice 103a sends Bob 103b the Merkle proof of TxID_{puzzle} on chain and the value h₂. Note that the information passed to Bob 103b relates to the puzzle transaction (which is published on chain). The sale transaction TxIDₛₐₗₑ is a secret held by Alice 103a as a template at this stage.

In some examples, Bob 103b may receive the value h₂ from Alice 103a as in 621b. In other examples, Bob 103b may retrieve value h₂ from first blockchain 150a as shown in 621a.

The value h₂ now plays two roles. It is:
the hash digest that Bob must find the preimage of to solve the access puzzle, and
the double hash of the message that must be signed to authorise the spend of Bob's payment UTXO (TxIDₛₑₜᵤₚ ∥ 0).

At 623, Bob 103b may check that TxID_{puzzle} has the same value of h₂ he received from Alice 103a (if he did receive a value of h₂ at 621b rather than retrieving the value of h₂ using 621a) and that the locking script also contains P2PKH P_{B2}*. The value of h₂ received by bob 103b from Alice 103a may be considered to be a candidate value. If so, Bob 103b knows that Alice 103a cannot use Bob's signature to authorise the sale transaction without revealing the transaction details that the secret requires for access.

At 623, Bob 103b signs h₂ using the private key associated with P_{B1}* and sends the signature to Alice 103a at 625.

At 627, once any conditions of Bob's access have been met (for example identity verification based on data supplied by Bob), Alice 103a applies Bob's signature to TxIDₛₐₗₑ template generated by Alice at 615. Since Bob 103b signed a signature message derived using the S|ACP sighash flag in this example, the resulting signature places no restrictions on the information in any of the inputs or outputs in other index positions. This means Alice 103a is free to combine payments from multiple users into a single transaction without invalidating any of the users' signatures. Alice 103a may include the signature in the unlocking script of the first transaction and then sending the first transaction to the second blockchain.

TABLE 5
TxIDₛₐₗₑ generated at 627 and published at 629.
TxIDₛₐₗₑ
Version

| | Input | | | Output | |
|---|---|---|---|---|---|
| | | Unlocking | | | Locking |
| Index | Outpoint | Script | nSeq | Value | Script |
| . . . | . . . | . . . | . . . | . . . | . . . |
| N | TxIDₛₑₜᵤₚ \|\| 0 | <Sig S\ACP><P_{B1}*> | n_{N} | fee | P2PKH P_{A}* |
| . . . | . . . | . . . | . . . | . . . | . . . |

Locktime

Alice 103a publishes the sale transaction at 629 to the second blockchain 150b.

At 629, when Alice 103a sends TxIDₛₐₗₑ to be published, Alice 103a notifies Bob 103b. Alternatively, or additionally, Bob 103b can identify the transaction by monitoring blockchain 150b for the UTXO he created in TxIDₛₑₜᵤₚ or his public key P_{B1}*. At 631, Bob 103b derives the secret h₁ (the single hash of the S|ACP signature message based on the index where his UTXO is the input) that is required to spend the puzzle UTXO TxID_{puzzle} ∥ 0. Bob 103b can also determine the message m from the published TxIDₛₐₗₑ.

At 633, Bob 103b creates TxID_{access}, with TxID_{puzzle} ∥ 0 as an input. TxID_{access} may be considered to comprise a second transaction. In some examples, this UTXO has sufficient value to cover the transaction fee of the present transaction. The unlocking script required is the secret h₁ with a valid signature and associated public key P_{B2}*. When TxID_{access} is published and presented on chain, Bob's purchase from Alice 103a is triggered. This may comprise triggering access from Alice 103a to Bob 103b.

TABLE 6
TxID_{access} created at 633.
TxID_{access}
Version

| | Input | | | Output | |
|---|---|---|---|---|---|
| Index | Outpoint | Unlocking Script | nSeq | Value | Locking Script |
| 0 | TxID_{puzzle} ∥ 0 | < h₁ > < sig P*_{B2}> <P*_{B2}> | n₀ | dust | P2PKH P_{B} |

Locktime

The method and system of FIG. 6 ensures that Alice 103a cannot collect Bob's fee without granting Bob 103b access (or providing him with relevant goods or services)+. TxIDₛₐₗₑ simultaneously transfers the access fee to Alice 103a and reveals the access secret to Bob 103b, implementing what can be thought of as an atomic swap.

If Bob 103b decides to withdraw his application before this swap occurs, he can create an alternative transaction that spends TxIDₛₑₜᵤₚ∥ 0. Bob's fee is returned and TxIDₛₐₗₑ is no longer valid, so the access secret cannot be revealed on-chain. Similarly, if the conditions for Bob's access are not met (for example the identity verification fails), Alice 103a cannot publish TxIDₛₐₗₑ, and Bob 103b retains control of TxIDₛₑₜᵤₚ ∥ 0.

The fact that the puzzle UTXO is locked to Bob's public key means that even though Alice 103a knows the required secret, she cannot spend the puzzle UTXO. For this reason, the puzzle UTXO may have a dust (or even zero) value, in case access is not granted to Bob 103b. However, the signature requirement is an important aspect of the system as it ensures that Alice 103a, upon receiving Bob's signature for TxIDₛₐₗₑ, cannot deny Bob 103b access by spending the puzzle UTXO herself before she publishes TxIDₛₐₗₑ.

In the example of FIG. 6, TxIDₛₐₗₑ and TxID_{access} share no common public keys and appear independent to an outside observer, so user privacy is maintained.

In some examples, in TxID_{puzzle} it is possible to use an R-puzzle in place of a hash puzzle.

The secret, h₁, will be used as an ephemeral key during ECDSA signature generation, such that r=[h₁·G]ₓ The puzzle locking script checks that the appropriate value of r has been used.

As Bob 103b does not know the details of the output that Alice 103a defines for TxIDₛₐₗₑ, he cannot predict the value of the secret, h₁. However, the system requires Alice 103a to define her output address for the fee at the very beginning of the process, and it cannot be changed. This means that even if Alice 103a combines access tokens for multiple users into one TxIDₛₐₗₑ, there must be a unique output defined for each input. Relative to defining a single output, this substantially increases the transaction size and the associated transaction fee Alice 103a must pay.

In the below section “NONE | ACP tokens”, some of the tokens are adapted to give Alice 103a flexibility in controlling the output of TxIDₛₐₗₑ.

### NONE|ACP Tokens

In the example described above with respect to FIG. 6, a S|ACP sighash flag is used for TxIDₛₐₗₑ. A further example is now considered (also with respect to FIG. 6), with a NONE|ACP sighash flag used for TxIDₛₐₗₑ rather than S|ACP.

At 611, Bob 103b can request a unique public key P_{A}* from Alice 103a. Bob 103b may generate TxIDₛₑₜᵤₚ, in which he assigns the fee required for access to a 2-of-3 multisig account associated with P_{A}*, P_{B1}* and P_{B2}* Bob 103b may also include data pertaining to his application for access (e.g., encrypted identity proof) in an OP_RETURN of that output. The setup transaction is published on-chain.

TABLE 7
TxIDₛₑₜᵤₚ
TxIDₛₑₜᵤₚ
Version

| | Input | | | Output | |
|---|---|---|---|---|---|
| Index | Outpoint | Unlocking Script | nSeq | Value | Locking Script |
| 0 | Bob's input | < Sig ALL >< P_{B} > | n₀ | fee | Multisig 2-of-3 (P*_{B1}, P*_{B2}, |
| | | | | | P*_{A}) |
| | | | | | OP_RETURN <data> |
| 1 | | | | change | P2PKH P_{B} |

Locktime

At 613, Bob 103b sends details of the UTXO: TxIDₛₑₜᵤₚ ∥ 0 and another of his public keys P_{B3}* to Alice.

At 615, Alice 103a creates a template of TxIDₛₐₗₑ that has a multisig input but no output

TABLE 8
Template: TxIDₛₐₗₑ
Template: TxIDₛₐₗₑ
Version

| | Input | | | Output | |
|---|---|---|---|---|---|
| Index | Outpoint | Unlocking Script | nSeq | Value | Locking Script |

| | | |
|---|---|---|
| 0 | TxIDₛₑₜᵤₚ ∥ 0 | n₀ |

Locktime

At 615, Alice 103a uses a standard locktime but randomises n₀ so that Bob 103b does not know the full details of the input for TxIDₛₐₗₑ. The NONE|ACP signature message does not sign an output, but in this way the signature message (and its hash digest h₁) is based on information that is not known to Bob 103b until TxIDₛₐₗₑ is published on-chain.

Alice 103a calculates h₁ and h₂, the single- and double-hash of the NONE|ACP signature message, m, of the template for TxIDₛₐₗₑ:

$$m = [ Verison ] [ Hash ( {Outpoint}_{0} ) ] [ Hash ( {nSeq}_{0} ) ] [ {Outpoint}_{0} ] [ {LockScriptLength}_{0} ] [ {LockScript}_{0} ] [ {Value}_{0} ] [ {nSeq}_{0} ] [ Hash ( Empty ) ] [ Locktime ] [ NONE \vert ACP ]$$

As noted above, an R-puzzle may be used instead of a hashing algorithm to calculate h₁ and h₂. It should be noted that any other suitable algorithm may be used of a hashing algorithm or an R-puzzle algorithm.

At 617, Alice 103a creates TxID_{puzzle} with an input from Alice 103a that assigns a dust value to an output with a locking script hash puzzle that requires the secret h₁ to solve.

TABLE 9
TxID_{puzzle}
TxID_{puzzle}
Version

| | Input | | | Output | |
|---|---|---|---|---|---|
| Index | Outpoint | Unlocking Script | nSeq | Value | Locking Script |
| 0 | Alice's input | < Sig ALL >< P_{A} > | n₀ | dust | Puzzle |
| 1 | | | | x | P2PKH P_{A} |

Locktime

The puzzle in the locking script may take the following form:
OP_SHA256 <h₂> OP_EQUALVERIFY P2PKH P₃

Alice 103a signs TxID_{puzzle} and it is published at 619. At 621b, Alice 103a sends Bob 103b the location of TxID_{puzzle} on chain and the value h₂. Bob 103b can then use this to retrieve TxID_{puzzle}. Alternatively, Bob 103b can retrieve TxID_{puzzle} directly from blockchain 150a at 621a.

At 623, Bob 103b checks that TxID_{puzzle} has the same value of h₂ he received from Alice 103a, and that the locking script also contains P2PKH P_{B3}*. If so, Bob 103b knows that Alice 103a cannot use Bob's signature to authorise the sale transaction without revealing the transaction details that the secret he requires for access, h₁, is derived from. Bob 103b signs h₂ using the private key associated with P_{B1}* (or P_{B2}*) and sends the signature to Alice 103a at 625.

At 627, once any conditions of Bob's access have been met (for example identity verification based on the data supplied by Bob 103b), Alice 103a applies Bob's signature to TxIDₛₐₗₑ.

Since Bob 103b and other users signed a signature message derived using the NONE|ACP sighash flag, Alice 103a can combine payments from multiple users as inputs into a single transaction without invalidating any of the users' signatures. As the outputs have not been signed, Alice 103a can set just one output collating the fees from all users to a single address.

TABLE 10
TxIDₛₐₗₑ
TxIDₛₐₗₑ
Version

| | Input | | | Output | |
|---|---|---|---|---|---|
| Index | Outpoint | Unlocking Script | nSeq | Value | Locking Script |
| . . . | . . . | . . . | . . . | Fee total | P2PKH P_{A} |
| N | TxIDₛₑₜᵤₚ ∥ 0 | < Sig NONE\|ACP > | n_{N} | | |
| | | < P*_{B1} > | | | |
| | | < Sig ALL >< P*_{A} > | | | |
| . . . | . . . | . . . | . . . | | |

Locktime

At 627, Alice 103a adds her own signature to complete the multisig requirement. Alice's signature can use a sighash that signs the output details, such as sighash ALL, to ensure that her output cannot be modified.

At 629, Alice 103a publishes TxIDₛₐₗₑ on chain.

At 631, Bob 103b identifies TxIDₛₐₗₑ based on the UTXO or his public key. Bob derives the secret h₁ (the single hash of the NONE|ACP signature message based on the index where his UTXO is the input) that is required to spend the puzzle UTXO TxID_{puzzle} ∥ 0.

At 633, Bob 103b creates TxID_{access}, with TxID_{puzzle} ∥ 0 as an input. The unlocking script required is the secret h₁ with a valid signature and associated public key P_{B3}*. Bob 103b may include an additional input to fund the transaction fee, since the puzzle UTXO had a dust value. When TxID_{access} is published on chain at 635, Bob's access is triggered.

TABLE 11
TxID_{access}
TxID_{access}
Version

| | Input | | | Output | |
|---|---|---|---|---|---|
| | | Unlocking | | | Locking |
| Index | Outpoint | Script | nSeq | Value | Script |
| 0 | TxID_{puzzle} ∥ 0 | < h₁ > < sig P*_{B3} > <P*_{B3}> | n₀ | x | P2PKH P_{B} |
| 1 | Bob's Input | < sig P_{B} > <P_{B}> | n₁ | | |

Locktime

When using the NONE|ACP sighash flag, by basing the secret, h₁ on the NONE|ACP sighash flag, users do not fix the details of any outputs when they sign h₂. This allows Alice 103a to set the output details of TxIDₛₐₗₑ at the point when she finalises the transaction, and means she only needs to define a single output, which will reduce the transaction fee for TxIDₛₐₗₑ, and simplifies Alice's key management. To secure the output details, Alice 103a can provides a signature, which in some examples can be achieved by setting the inputs that contain users' fees to have a multisig requirement.

Alice 103a controls one key for the multisig UTXOs, two signatures are required to authorise the spend, and so Alice 103a cannot take the fee without Bob's agreement. Bob 103b controls two of the keys, and therefore retains the power to abort the protocol if necessary, by producing the required two signatures to spend the multisig UTXO.

Although the NONE|ACP system may reduce the size of TxIDₛₐₗₑ by limiting the number of outputs that are necessary, having multisig requirements for the inputs may counteract this due to increased unlocking script sizes. Threshold signature systems can provide many of the benefits of a multisig system without inflating transaction sizes, but they cannot be applied in the system designed here since they require all parties to sign the same signature message (i.e., Alice 103a could not use a different sighash flag to Bob 103b).

An alternative solution that does not require introducing any signature from Alice 103a is for Alice 103a to have an arrangement with a trusted block producer, via whom the TxIDₛₐₗₑ can be published without being broadcast to the wider network. In this case the inputs to TxIDₛₐₗₑ could remain P2PKH UTXOs locked to a single user's public key, as described in above with respect to FIG. 6 for the S|ACP tokens.

Bob 103b should not be able to guess or brute force compute the value of the secret. For the S|ACP tokens Bob cannot know the details of Alice's output until the transaction is published on-chain. Any P2PKH locking script will contain a 20 byte (160 bit) public key, which is considered secure enough to prevent brute force attacks. (If additional security is required, Alice 103a could include an additional secret nonce of any size in the output locking script—for example using OP_PUSH OP_DROP or OP_RETURN—to increase the security level). In contrast, for NONE|ACP tokens, the output is not included in the derivation of h₁, and so it cannot be the unknown element in the signature message. Using the sequence number of the input as the value that is unknown to Bob 103b. However, the nSeq field is in some examples limited in size (4 bytes=32 bits) making a brute force attack by Bob much more feasible. Other values that are included in the signature message are the version and the locktime. However, these values may in some examples both also be capped at 4 bytes, so if Alice 103a were to set all three values randomly (and note that locktime cannot be set entirely randomly without delaying the publication of the transaction), the security would only be 96 bits. Thus, the system described using NONE|ACP sighash flags may be more appropriate for situations where Bob's computational power is constrained, e.g., a device connected to the IoT network, and the time between Alice 102a passing h₂ to Bob 102b and Bob 102b exercising his access is short. In situations where Bob 102b has high computational power or the time between Alice 102a passing h₂ to Bob 102b and Bob 102b exercising his access is long, it may be preferred to use a S|ACP sighash flag for TxIDₛₐₗₑ.

### Chained Secret Access Tokens

In some examples, the secret access tokens are chained. One use of this could be in supply chain management, for example, as each transfer between parties in the supply chain takes place, a transaction is made on-chain that reveals the secret required for the party who is handing off the goods to be paid. The swap may occur between the goods and the payment for the stage of the supply chain that has just been completed.

For example, consider a supply chain in which there is an oracle, Alice 103a, two parties, Bob 103b and Charlie 103c, who are responsible for goods within the chain, and a final party, Debbie 103d, who receives the goods. It will be understood that in some examples, a similar method could be used with a different number of parties in the supply chain may be used.

In some examples, the final party, Debbie 103d, could act as the oracle for the supply chain, and would assume the roles assigned to Alice. The notation described above is applied, where each party owns public keys denoted by their initial as a subscript, and where keys without the * superscript are a generic label for a set of single-use keys belonging to a party.

At 741a, the first party in the chain, Bob 103b, sends Alice 103a the details of a UTXO he controls on chain (TxID_{Bob} ∥ i_{B}) associated with P_{B1}*. For simplicity we assume this UTXO has a value that is sufficient to cover the transaction fees for the chain of transactions with a dust amount left over. Bob 103b also sends Alice another of his public keys, P_{B2}*. At 741b, parties in the middle of the chain (Charlie 103c, here) send Alice 103a two unused public keys, and at 741c the final party in the chain Debbie 103d sends Alice 103a one unused public key. Alice 103a knows the details of P_{B1}*, P_{B2}*, P_{C1}*, P_{C2}*, P_{D1}*. Chain parties do not know the details of each other's public keys.

At 743, Alice 103a creates templates for each transaction that will occur in the chain, and calculates a secret based on each transaction. In this example. Alice 103a creates a template for transactions TxID_{chain1} (considered a first transaction in this example) and TxID_{chain2} (considered a third transaction in this example), which represent the handover points in the supply chain. Alice 103a knows the details of the inputs and outputs that will form these transactions, but these details are not known by the parties in the chain.

TABLE 12
TxID_{chain1}
Template: TxID_{chain1}
Version

| | Input | | | Output | |
|---|---|---|---|---|---|
| Index | Outpoint | Unlocking Script | nSeq | Value | Locking Script |

| | | | | |
|---|---|---|---|---|
| 0 | TxID_{Bob} ∥ i_{B} | n₀ | x | P2PKH P*_{C1} |

Locktime

TABLE 13
TxID_{chain2}
Template: TxID_{chain2}
Version

| | Input | | | Output | |
|---|---|---|---|---|---|
| Index | Outpoint | Unlocking Script | nSeq | Value | Locking Script |

| | | | | |
|---|---|---|---|---|
| 0 | TxID_{chain1} ∥ 0 | n₀ | dust | P2PKH P*_{D1} |

Locktime

From each transaction, Alice 103a can calculate the signature message that will be used. Note that this could be a S|ACP sig hash flag, as described above but it could also be an ALL flag since the chain transactions are not expected to contain any other inputs or outputs. The message for TxID_{chain1} using a sighash ALL flag would be:

$${m}_{1} = [ Verison ] [ Hash ( {Outpoint}_{0} ) ] [ Hash ( {nSeq}_{0} ) ] [ {Outpoint}_{0} ] [ {LockScriptLength}_{0} ] [ {LockScript}_{0} ] [ {Value}_{0} ] [ {nSeq}_{0} ] [ Hash ( {Output}_{0} ) ] [ Locktime ] [ ALL ]$$

from which Alice 103a can calculate the secret value h₁ and its hash h₁₂. These will be used as the basis for the puzzle that Bob 103b will need to solve to get his payment. Alice 103a can perform the same operations on TxID_{chain2} to derive m₂ (a second message), h₂₁ (a second secret) and h₂₂ (a second Value, which is based on the second secret).

At 745a, Alice 103a sends the details of the template for TxID_{chain1} to Charlie 103c only. The details of the template for TxID_{chain1} are not sent to Bob 103b. At 745b, Alice 103a sends the details of the template for TxID_{chain2} to Debbie 103d only. The details of the template for TxID_{chain2} are not sent to Charlie 103c.

At 747, Alice 103a creates a puzzle transaction that contains the payments to Bob 103b and Charlie 103c for their part in the supply chain. Bob 103b and Charlie 103c, as parties within the supply chain, require payment for their service. Alice 103a creates a puzzle transaction with two outputs, which may have the following locking scripts:
Puzzle₁: OP_SHA256 <h₁₂> OP_EQUALVERIFY P2PKH P_{B2}*
Puzzle₂: OP_SHA256 <h₂₂> OP_EQUALVERIFY P2PKH P_{C2}*

TABLE 14
TxID_{puzzle}
TxID_{puzzle}
Version

| | Input | | | Output | |
|---|---|---|---|---|---|
| Index | Outpoint | Unlocking Script | nSeq | Value | Locking Script |
| 0 | Alice's input | < Sig ALL >< P_{A} > | n₀ | Pay₁ | Puzzle₁ |
| 1 | | | | Pay₂ | Puzzle₂ |
| 2 | | | | x | P2PKH P_{A} |

Locktime

Puzzle₁ and Puzzle₂ may comprise independent puzzles, or the Puzzle₁ may comprise Puzzle₂.

At 749, Alice 103a signs and publishes the puzzle transaction. Alice 103a sends Bob 103b the Merkle proof of TxID_{puzzle} and the value h₁₂. Alice 103a sends Charlie 103c the Merkle proof of TxID_{puzzle} and the value h₂₂.

At 751, Bob 103b transfers goods to Charlie 103c. Bob 103b checks that TxID_{puzzle1} online contains his expected fee, that the public key it locks the funds to is P_{B2}*, and that the value h₁₂ in the puzzle script is the same as the value that Alice 103a sent to him. Bob 103b delivers the goods to Charlie 103c. Bob 103b produces a signature using the message h₁₂ using the private key associated with P_{B1}*. Bob 103b gives the signature to Charlie 103c, and at 753 Charlie who can apply the signature to the template of TxID_{chain1}, and then publishes TxID_{chain1} online. Bob 103b verifies the transaction has been published at 757 and transfers the goods to Charlie 103c at 759.

TABLE 15
TxID_{chain1}
TxID_{chain1}
Version

| | Input | | | Output | |
|---|---|---|---|---|---|
| Index | Outpoint | Unlocking Script | nSeq | Value | Locking Script |
| 0 | TxID_{Bob} ∥ i_{B} | < sig P*_{B1} > | n₀ | x | P2PKH P*_{C1} |
| | | <P*_{B1}> | | | |

Locktime

At 761, Bob 103b can collect his payment. From the details of TxID_{chain1}, Bob 103b, can calculate h₁₁, which is the secret that is required to unlock the output in TxID_{puzzle} that contains Bob's payment.

TABLE 16
TxID_{PayBob}
TxID_{PayBob}
Version

| | Input | | | Output | |
|---|---|---|---|---|---|
| Index | Outpoint | Unlocking Script | nSeq | Value | Locking Script |
| 0 | TxID_{puzzle} ∥ 0 | < h₁₁ > | n₀ | Pay₁ | P2PKH P_{B} |
| | | < sig P*_{B2} > | | | |
| | | <P*_{B2}> | | | |

Locktime

At 763, Charlie 103c transfers goods to Debbie. Charlie 103c checks that TxID_{puzzle2} online contains his expected fee, that the public key it locks the funds to is P_{C2}*, and that the value h₂₂ in the puzzle script is the same as the value that Alice 103a sent to him. Charlie 103c delivers the goods to Debbie 103d. Charlie 103c produces a signature using the message h₂₂ using the private key associated with P_{C1}*. Charlie 103c gives the signature to Debbie 103d, who can apply it to the template of TxID_{chain2} at 765 and publishes TxID_{chain2} online at 766. At 767, Charlie 103c verifies the transaction has been published and transfers the goods to Debbie 103d.

TABLE 17
TxID_{chain2}
TxID_{chain2}
Version

| | Input | | | Output | |
|---|---|---|---|---|---|
| Index | Outpoint | Unlocking Script | nSeq | Value | Locking Script |
| 0 | TxID_{chain1} ∥ 0 | < sig P*_{C1} > | n₀ | dust | P2PKH P*_{D1} |
| | | <P*_{C1}> | | | |

Locktime

At 771, Charlie 103c can obtain his payment. From the details of TxID_{chain2}, Charlie 103c, can calculate h₂₁, which is the secret that is required to unlock the output in TxID_{puzzle} that contains Charlie's payment.

TABLE 18
TxID_{PayCharlie}
TxID_{PayCharlie}
Version

| | Input | | | Output | |
|---|---|---|---|---|---|
| | | Unlocking | | | Locking |
| Index | Outpoint | Script | nSeq | Value | Script |
| 0 | TxID_{puzzle} ∥ 1 | < h₂₁ > | n₀ | Pay₂ | P2PKH |
| | | < sig P*_{C2} > | | | P_{C} |
| | | <P*_{C2}> | | | |

Locktime

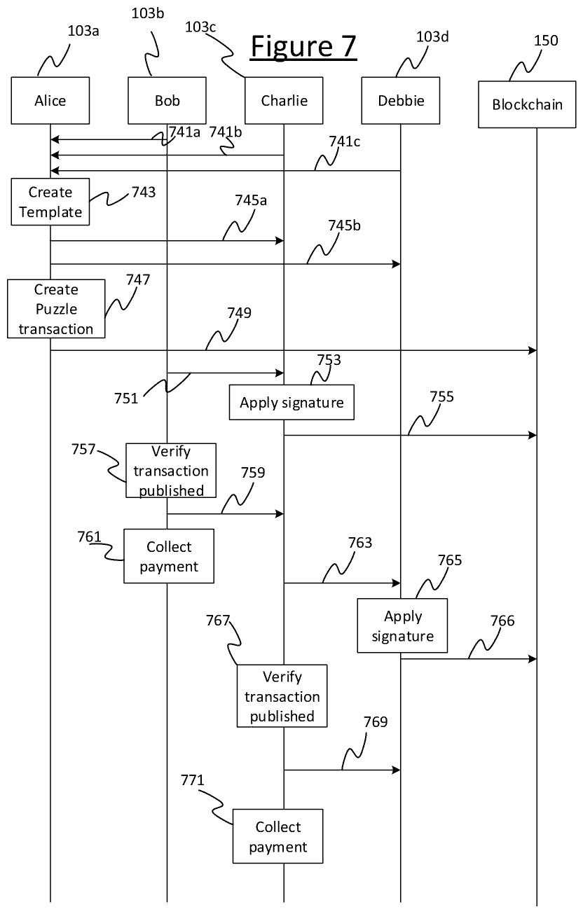

The method as described above with respect to FIG. 7 allows each party in the chain to transfer the goods to the subsequent party knowing that they will be paid. By waiting for the publication of the corresponding chain transaction on chain, each party knows the secret they require to unlock their payment is available to them.

If two parties were to collude, for example, that Charlie 103c agreed to share the details of TxID_{chain1} (from which Bob 103b can determine the secret he requires for payment) with Bob 103b, without the transfer of goods occurring, then Charlie 103c knows that he cannot deliver the goods to Debbie 104d, and therefore will not receive his payment. Even if Bob 103b says he will split the fee he receives with Charlie 103c, Charlie 103c has no proof this will occur, and so is not motivated to collude.

For the puzzle transactions, a check that a signature from the expected chain party is included in the unlocking script can be included to ensure the fees cannot be stolen by another party once the secret value is revealed on-chain. For this use case it may be appropriate for the locking script of the puzzle transactions to have a 1-of-2 multisig signing condition (with Alice 103a as one possible signatory), so that if the chain party does not fulfil their role, the funds are not locked in the puzzle UTXO. In this situation, Alice 103a is a trusted party who is independent from the supply chain.

The system can be adapted to integrate information from IoT devices, for example a thermometer packed with the goods, to ensure that the agreed conditions of the supply service are met. To implement this, the puzzle transaction (which contains the payment) could have a 1-of-n signature requirement (the chain party plus n−1 IoT devices). All IoT devices would have the details of the secret so that they can spend the puzzle transaction at any time and would be programmed to spend the transaction under certain conditions, for example if the temperature of the goods exceeded a certain threshold.

### Cross Chain

Note that although they are linked by the secret value h₂, TxIDₛₐₗₑ and TxID_{puzzle} are entirely independent in terms of inputs and outputs. Therefore, TxIDₛₐₗₑ and TxID_{puzzle} could occur on different blockchains. This would allow for an atomic swap to occur between the two chains (e.g., blockchain 150a and blockchain 150b in an example where these blockchains are different from each other). This could be used for example for exchanging coins or tokens in one chain for those in another.

Both parties involved in the exchange would need to control public keys on both chains. If TxIDₛₐₗₑ occurs on chain 1 (Table 19 below) then TxD_{puzzle} occurs on chain 2 (Table 20 below). Bob's UTXO on chain 1 is exchanged for Alice's UTXO on chain 2.

TABLE 19
TxIDₛₐₗₑ (Chain 1)
TxIDₛₐₗₑ (Chain 1)
Version

| | Input | | | Output | |
|---|---|---|---|---|---|
| | | Unlocking | | | Locking |
| Index | Outpoint | Script | nSeq | Value | Script |
| 0 | Bob's UTXO | < Sig ALL >< P_{B}¹ > | n_{B} | x | P2PKH |
| | | | | | P_{A}¹ |

Locktime

TABLE 20
TxID_{puzzle} (Chain 2)
TxID_{puzzle} (Chain 2)
Version

| | Input | | | Output | |
|---|---|---|---|---|---|
| | | Unlocking | | | Locking |
| Index | Outpoint | Script | nSeq | Value | Script |
| 0 | Alice's UTXO | < Sig ALL >< P_{A}² > | n_{A} | y | Puzzle |
| | | | | | to P_{B}² |

Locktime

### CONCLUSION

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However, it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all the described functions of creating, publishing, propagating, and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all the functions of creating, publishing, propagating, and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all the roles of creating, publishing, propagating, and storing blocks. The functions of such a network entity/element may be implemented in hardware in the same way described above with reference to a blockchain node 104.

It will be appreciated that the above embodiments have been described by way of example only. More generally there may be provided a method, apparatus, or program in accordance with any one or more of the following Statements.

Statement 1: A method performed in a system comprising a first party and a second party, the method comprising: generating, by the first party, a template of a first transaction having an input based on an output from a prior transaction associated with the second party; generating, by the first party, a message based on the template of the first transaction; generating, by the first party, a secret based on the message; generating, by the first party, a value based on the secret, wherein the secret cannot be derived from the value; generating, by the first party, a first puzzle transaction, wherein a first locking script of the first puzzle transaction comprises a knowledge proof configured to require an unlocking script to comprise the secret; publishing, by the first party, the first puzzle transaction to a first blockchain; obtaining, by the second party, the value based on the secret; signing, by the second party, the value based on the secret to create a signature; sending the signature from the second party to the first party; including, by the first party, the signature in the unlocking script of the first transaction and then sending the first transaction to the second blockchain; determining, by the second party and from the first transaction on the second blockchain, the message and the secret; and creating, by the second party, a second transaction which unlocks a first output of the first puzzle transaction based on the secret, and submitting the second transaction to the first blockchain.

Statement 2: A method according Statement 1, wherein an output of the first transaction is locked to a public key of the first party.

Statement 3: A method according to any preceding Statement, wherein the first puzzle transaction is locked to a public key of the second party.

Statement 4: A method according to any preceding Statement, wherein obtaining, by the second party, the value based on the secret, comprises: obtaining, by the second party, the value based on the secret from the first puzzle transaction; and wherein the method comprises: receiving, by the second party and from the first party, a candidate value for the value based on the secret from the first puzzle transaction; checking, by the second party, that the candidate value and the value based on the secret from the first puzzle transaction are equal.

Statement 5: A method according to any preceding Statement, wherein the secret comprises an input and corresponding output of the first transaction.

Statement 6: A method according to any preceding Statement, wherein the secret comprises all inputs and all outputs of the first transaction.

Statement 7: A method according to any of Statements 1 to 5, wherein the secret comprises an input of the first transaction and none of the outputs of the first transaction.

Statement 8: A method according to any preceding Statement, wherein an input of the first transaction unlocks a multiple signature output of the prior transaction, wherein the multiple signature output is locked to one or more public keys of: the first party; and/or the second party.

Statement 9: A method according to any preceding Statement, wherein the first transaction comprises an output locked to the public key of a third party, and wherein the method comprises: generating, by the first party, a template of a third transaction that spends the output of the first transaction; generating, by the first party, a second message based on the template of the third transaction; generating, by the first party, a second secret based on the second message; generating, by the first party, a second value based on the second secret, wherein the second secret cannot be derived from the second value; generating, by the first party, a second puzzle transaction, wherein a second locking script of the second puzzle transaction comprises a knowledge proof configured to require a second unlocking script to comprise the second secret; signing, by a third party, the second value based on the second secret to create a second signature; sending the second signature from the third party to a fourth party; obtaining, by a fourth party, the third transaction, including, by the fourth party, the second signature in an unlocking script of the third transaction and then sending the third transaction to the second blockchain; determining, by the third party and from the third transaction on the second blockchain, the second message and the second secret; and creating, by the third party, a fourth transaction which unlocks an output of the second puzzle transaction based on the second secret, and submitting the second transaction to the first blockchain.

Statement 9A. A method according to any of Statements 1 to 8, wherein a fifth transaction comprises an output locked to the public key of a third party, and wherein the method comprises: generating, by the first party, a template of a third transaction that spends the output of the fifth transaction; generating, by the first party, a second message based on the template of the third transaction; generating, by the first party, a second secret based on the second message; generating, by the first party, a second value based on the second secret, wherein the second secret cannot be derived from the second value; generating, by the first party, a second puzzle transaction, wherein a second locking script of the second puzzle transaction comprises a knowledge proof configured to require a second unlocking script to comprise the second secret; signing, by a third party, the second value based on the second secret to create a second signature; sending the second signature from the third party to a fourth party; obtaining, by a fourth party, the third transaction, including, by the fourth party, the second signature in an unlocking script of the third transaction and then sending the third transaction to the second blockchain; determining, by the third party and from the third transaction on the second blockchain, the second message and the second secret; and creating, by the third party, a fourth transaction which unlocks an output of the second puzzle transaction based on the second secret, and submitting the second transaction to the first blockchain.

Statement 10: A method according to Statement 9 or Statement 9A, wherein the first puzzle transaction and second puzzle transaction are independent puzzle transactions.

Statement 11: A method according to Statement 9 or Statement 9A, wherein the first puzzle transaction comprises the second puzzle transaction.

Statement 12: A method according to any preceding Statement, wherein the first blockchain and the second blockchain are different blockchains.

Statement 13: A method according to any preceding Statement, wherein the first blockchain and the second blockchain are the same blockchain.

Statement 14: A method according to any preceding Statement, wherein the secret is generated by hashing the message.

Statement 15: A method according to any preceding Statement, wherein the secret is generated by using an R-puzzle.

Statement 16: A method performed by a first party, the method comprising: generating a template of a first transaction having an input based on an output from a prior transaction associated with a second party; generating a message based on the template of the first transaction; generating a secret based on the message; generating a value based on the secret, wherein the secret cannot be derived from the value; generating a first puzzle transaction, wherein a first locking script of the first puzzle transaction comprises a knowledge proof configured to require an unlocking script to comprise the secret; publishing the first puzzle transaction to a first blockchain; receiving a signature from the second party, wherein the signature is created by the second party using the value based on the secret; including the signature in the unlocking script of the first transaction and then sending the first transaction to the second blockchain.

Statement 17: A method according to Statement 16, wherein an output of the first transaction is locked to a public key of the first party.

Statement 18: A method according to Statement 16 or 17, wherein the first puzzle transaction is locked to a public key of the second party.

Statement 19: A method according to any of Statements 16 to 18, comprising: sending, to the second party, a candidate value for the value based on the secret from the first puzzle transaction.

Statement 20: A method according to any of Statements 16 to 19, wherein the secret comprises an input and corresponding output of the first transaction.

Statement 21: A method according to any of Statements 16 to 20, wherein the secret comprises all inputs and all outputs of the first transaction.

Statement 22: A method according to any of Statements 16 to 21, wherein the secret comprises an input of the first transaction and none of the outputs of the first transaction.

Statement 23: A method according to any of Statements 16 to 22, wherein an input of the first transaction unlocks a multiple signature output of the prior transaction, wherein the multiple signature output is locked to one or more public keys of: the first party; and/or or the second party.

Statement 24: A method according to any of Statements 16 to 23, wherein the first transaction comprises an output locked to the public key of a third party, and wherein the method comprises: generating a template of a third transaction that spends the output of the first transaction; generating a second message based on the template of the third transaction; generating a second secret based on the second message; generating a second value based on the second secret, wherein the second secret cannot be derived from the second value; and generating, by the first party, a second puzzle transaction, wherein a second locking script of the second puzzle transaction comprises a knowledge proof configured to require a second unlocking script to comprise the second secret.

Statement 24A: A method according to any of Statements 16 to 23, wherein a fifth transaction comprises an output locked to the public key of a third party, and wherein the method comprises: generating a template of a third transaction that spends the output of the fifth transaction; generating a second message based on the template of the third transaction; generating a second secret based on the second message; generating a second value based on the second secret, wherein the second secret cannot be derived from the second value; and generating, by the first party, a second puzzle transaction, wherein a second locking script of the second puzzle transaction comprises a knowledge proof configured to require a second unlocking script to comprise the second secret.

Statement 25: A method according to Statement 24 or Statement 24A, wherein the first puzzle transaction and second puzzle transaction are independent puzzle transactions.

Statement 26: A method according to Statement 24 or Statement 24A, wherein the first puzzle transaction comprises the second puzzle transaction.

Statement 27: A method according to any of Statements 16 to 26, wherein the first blockchain and the second blockchain are different blockchains.

Statement 28: A method according to any of Statements 16 to 27, wherein the first blockchain and the second blockchain are the same blockchain.

Statement 29: A method according to any of Statements 16 to 28, wherein the secret is generated by hashing the message.

Statement 30: A method according to any of Statements 16 to 29, wherein the secret is generated by using an R-puzzle.

Statement 31: A method performed by a second party, the method comprising: obtaining a value generated by a first party based on a secret, wherein the secret cannot be derived from the value, wherein the secret is based on a message generated by the first party based on a template of a first transaction, and wherein a template of the first transaction has an input based on an output from a prior transaction associated with the second party; signing the value based on the secret to create a signature; sending the signature to the first party, wherein the first party includes the signature in the unlocking script of the first transaction and then sends the first transaction to the second blockchain; determining, from the first transaction on the second blockchain, the message and the secret; and creating, by the second party, a second transaction which unlocks a first output of a first puzzle transaction based on the secret, and submitting the second transaction to the first blockchain, wherein a first locking script of the puzzle transaction comprises a knowledge proof configured to require an unlocking script to comprise the secret.

Statement 32: A method according to Statement 31, wherein the first transaction is locked to a public key of the first party.

Statement 33: A method according to Statement 31 or Statement 32, wherein the first puzzle transaction is locked to a public key of the second party.

Statement 34: A method according to any of Statements 31 to 33, wherein obtaining the value based on the secret, comprises: obtaining the value based on the secret from the first puzzle transaction; and wherein the method comprises: receiving, from the first party, a candidate value for the value based on the secret from the first puzzle transaction; checking that the candidate value and the value based on the secret from the first puzzle transaction are equal.

Statement 35: A method according to any of Statements 31 to 34, wherein the secret comprises an input and corresponding output of the first transaction.

Statement 36: A method according to any of Statements 31 to 35, wherein the secret comprises all inputs and all outputs of the first transaction.

Statement 37: A method according to any of Statements 31 to 34, wherein the secret comprises an input of the first transaction and none of the outputs of the first transaction.

Statement 38: A method according to any of Statements 31 to 37, wherein an input of the first transaction unlocks a multiple signature output of the prior transaction, wherein the multiple signature output is locked to one or more public keys of: the first party; and/or or the second party.

Statement 39: A method according to any of Statements 31 to 38, wherein the first transaction comprises an output locked to the public key of a third party, and wherein the first party performs: generating a template of a third transaction that spends the output of the first transaction; generating a second message based on the template of the third transaction; generating a second secret based on the second message; generating a second value based on the second secret, wherein the second secret cannot be derived from the second value; and generating, by the first party, a second puzzle transaction, wherein a second locking script of the second puzzle transaction comprises a knowledge proof configured to require a second unlocking script to comprise the second secret.

Statement 39A: A method according to any of Statements 31 to 38, wherein a fifth transaction comprises an output locked to the public key of a third party, and wherein the first party performs: generating a template of a third transaction that spends the output of the fifth transaction; generating a second message based on the template of the third transaction; generating a second secret based on the second message; generating a second value based on the second secret, wherein the second secret cannot be derived from the second value; and generating, by the first party, a second puzzle transaction, wherein a second locking script of the second puzzle transaction comprises a knowledge proof configured to require a second unlocking script to comprise the second secret.

Statement 40: A method according to Statement 39 or Statement 39A, wherein the first puzzle transaction and second puzzle transaction are independent puzzle transactions.

Statement 41: A method according to Statement 39 or Statement 39A, wherein the first puzzle transaction comprises the second puzzle transaction.

Statement 42: A method according to any of Statements 31 to 41, wherein the first blockchain and the second blockchain are different blockchains.

Statement 43: A method according to any to any of Statements 31 to 42, wherein the first blockchain and the second blockchain are the same blockchain.

Statement 44: A method according to any of Statements 31 to 43, wherein the secret is generated by hashing the message.

Statement 45: A method according to any of Statements 31 to 44, wherein the secret is generated by using an R-puzzle.

Statement 46: Computer equipment comprising: memory comprising one or more memory units; and processing apparatus comprising one or more processing units, wherein the memory stores code arranged to run on the processing apparatus, the code being configured so as when on the processing apparatus to perform the method of any of Statements 1 to 45.

Statement 47: A computer program embodied on computer-readable storage and configured as, when run on one or more processors, to perform the method of any of Statements 1 to 45.

According to another aspect disclosed herein, there may be provided a method comprising the actions of the first user and the second user.

According to another aspect disclosed herein, there may be provided a method comprising the actions of the first user.

According to another aspect disclosed herein, there may be provided a method comprising the actions of the second user.

According to another aspect disclosed herein, there may be provided a system comprising the computer equipment of the first user and the second user.

According to another aspect disclosed herein, there may be provided a system comprising the computer equipment of the first user.

According to another aspect disclosed herein, there may be provided a system comprising the computer equipment of the second user.

1. A method performed in a system comprising a first party and a second party, the method comprising:
generating, by the first party, a template of a first transaction having an input based on an output from a prior transaction associated with the second party;
generating, by the first party, a message based on the template of the first transaction;
generating, by the first party, a secret based on the message;
generating, by the first party, a value based on the secret, wherein the secret cannot be derived from the value;
generating, by the first party, a first puzzle transaction, wherein a first locking script of the first puzzle transaction comprises a knowledge proof configured to require an unlocking script to comprise the secret;
publishing, by the first party, the first puzzle transaction to a first blockchain;
obtaining, by the second party, the value based on the secret;
signing, by the second party, the value based on the secret to create a signature;
sending the signature from the second party to the first party;
including, by the first party, the signature in the unlocking script of the first transaction and then sending the first transaction to a second blockchain;
determining, by the second party and from the first transaction on the second blockchain, the message and the secret; and
creating, by the second party, a second transaction which unlocks a first output of the first puzzle transaction based on the secret, and submitting the second transaction to the first blockchain.

2. The method of claim 1, wherein an output of the first transaction is locked to a public key of the first party.

3. The method of claim 1, wherein the first puzzle transaction is locked to a public key of the second party.

4. The method of claim 1, wherein obtaining, by the second party, the value based on the secret, comprises: obtaining, by the second party, the value based on the secret from the first puzzle transaction; and wherein the method comprises:
receiving, by the second party and from the first party, a candidate value for the value based on the secret from the first puzzle transaction;
checking, by the second party, that the candidate value and the value based on the secret from the first puzzle transaction are equal.

5. The method of claim 1, wherein the secret comprises:
an input and corresponding output of the first transaction,
all inputs and all outputs of the first transaction; or
an input of the first transaction and none of the outputs of the first transaction.

6-7. (canceled)

8. The method of claim 1, wherein an input of the first transaction unlocks a multiple signature output of the prior transaction, wherein the multiple signature output is locked to one or more public keys of: the first party; and/or the second party.

9. The method of claim 1, wherein a fifth transaction comprises an output locked to a public key of a third party, and wherein the method comprises:
generating, by the first party, a template of a third transaction that spends the output of the fifth transaction;
generating, by the first party, a second message based on the template of the third transaction;
generating, by the first party, a second secret based on the second message;
generating, by the first party, a second value based on the second secret, wherein the second secret cannot be derived from the second value;
generating, by the first party, a second puzzle transaction, wherein a second locking script of the second puzzle transaction comprises a knowledge proof configured to require a second unlocking script to comprise the second secret;
signing, by a third party, the second value based on the second secret to create a second signature;
sending the second signature from the third party to a fourth party;
obtaining, by a fourth party, the third transaction,
including, by the fourth party, the second signature in an unlocking script of the third transaction and then sending the third transaction to the second blockchain;
determining, by the third party and from the third transaction on the second blockchain, the second message and the second secret; and
creating, by the third party, a fourth transaction which unlocks an output of the second puzzle transaction based on the second secret, and submitting the second transaction to the first blockchain.

10. The method of method according to claim 9, wherein the first puzzle transaction and second puzzle transaction are independent puzzle transactions.

11. The method of claim 9, wherein the first puzzle transaction comprises the second puzzle transaction.

12. The method of claim 1, wherein the first blockchain and the second blockchain are different blockchains.

13. The method of method according to claim 1, wherein the first blockchain and the second blockchain are the same blockchain.

14. The method of claim 1, wherein the secret is generated by hashing the message and/or by using an R-puzzle.

15. (canceled)

16. A method performed by a first party, the method comprising:
generating a template of a first transaction having an input based on an output from a prior transaction associated with a second party;
generating a message based on the template of the first transaction;
generating a secret based on the message;
generating a value based on the secret, wherein the secret cannot be derived from the value;
generating a first puzzle transaction, wherein a first locking script of the first puzzle transaction comprises a knowledge proof configured to require an unlocking script to comprise the secret;
publishing the first puzzle transaction to a first blockchain;
receiving a signature from the second party, wherein the signature is created by the second party using the value based on the secret;
including the signature in the unlocking script of the first transaction and then sending the first transaction to a second blockchain.

17. The method of m claim 16, wherein an output of the first transaction is locked to a public key of the first party.

18. The method of claim 16, wherein the first puzzle transaction is locked to a public key of the second party.

19. The method of claim 16,
comprising: sending, to the second party, a candidate value for the value based on the secret from the first puzzle transaction.

20. The method of claim 16, wherein the secret comprises an input and corresponding output of the first transaction.

21-30. (canceled)

31. A method comprising:
obtaining, by a second party, a value generated by a first party based on a secret, wherein the secret cannot be derived from the value, wherein the secret is based on a message generated by the first party based on a template of a first transaction, and wherein the template of the first transaction has an input based on an output from a prior transaction associated with the second party;
signing, by the second party, the value based on the secret to create a signature;
sending the signature to the first party from the second party, wherein the first party includes the signature in an unlocking script of the first transaction and then sends the first transaction to a second blockchain;
determining, by the second party and from the first transaction on the second blockchain, the message and the secret; and
creating, by the second party, a second transaction which unlocks a first output of a first puzzle transaction based on the secret, and submitting the second transaction to the first blockchain, wherein a first locking script of the first puzzle transaction comprises a knowledge proof configured to require an unlocking script to comprise the secret;
wherein the template of the first transaction, the secret and the first puzzle transaction are generated by the first party.

32-45. (canceled)

46. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method performed in a system comprising a first party and a second party, the method comprising:
generating, by the first party, a template of a first transaction having an input based on an output from a prior transaction associated with the second party;
generating, by the first party, a message based on the template of the first transaction;
generating, by the first party, a secret based on the message;
generating, by the first party, a value based on the secret, wherein the secret cannot be derived from the value;
generating, by the first party, a first puzzle transaction, wherein a first locking script of the first puzzle transaction comprises a knowledge proof configured to require an unlocking script to comprise the secret;
publishing, by the first party, the first puzzle transaction to a first blockchain;
obtaining, by the second party, the value based on the secret;
signing, by the second party, the value based on the secret to create a signature;
sending the signature from the second party to the first party;
including, by the first party, the signature in the unlocking script of the first transaction and then sending the first transaction to a second blockchain;
determining, by the second party and from the first transaction on the second blockchain, the message and the secret; and
creating, by the second party, a second transaction which unlocks a first output of the first puzzle transaction based on the secret, and submitting the second transaction to the first blockchain.

47. A computer program embodied on non-transitory computer-readable storage media and configured as, when run on one or more processors, the one or more processors perform a method performed in a system comprising a first party and a second party, the method comprising:
generating, by the first party, a template of a first transaction having an input based on an output from a prior transaction associated with the second party;
generating, by the first party, a message based on the template of the first transaction;
generating, by the first party, a secret based on the message;
generating, by the first party, a value based on the secret, wherein the secret cannot be derived from the value;
generating, by the first party, a first puzzle transaction, wherein a first locking script of the first puzzle transaction comprises a knowledge proof configured to require an unlocking script to comprise the secret;
publishing, by the first party, the first puzzle transaction to a first blockchain;
obtaining, by the second party, the value based on the secret;
signing, by the second party, the value based on the secret to create a signature;
sending the signature from the second party to the first party;
including, by the first party, the signature in the unlocking script of the first transaction and then sending the first transaction to a second blockchain;
determining, by the second party and from the first transaction on the second blockchain, the message and the secret; and
creating, by the second party, a second transaction which unlocks a first output of the first puzzle transaction based on the secret, and submitting the second transaction to the first blockchain.
